(19) United States
(12) Patent Application Publication
(10) Pub. No.: US 2004/0147675 A1
(43) Pub. Date: Jul. 29, 2004

(54) Thermoplastic elastomers from crosslinked polyvinylbutyral

(76) Inventor: George H. Hofmann, Wilmington (DE)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/721,531

(22) Filed: Nov. 25, 2003

Related U.S. Application Data
(60) Provisional application No. 60/429,456, filed on Nov. 27, 2002.

(51) Int. Cl. C08L 29/00; C08L 67/02; C08F 8/30; C08L 77/00; C08L 23/00; C08L 23/04; C08L 25/02; C08L 1/00; C08F 8/00; C08F 283/02; C08F 283/00

(52) U.S. Cl. 525/165; 525/178; 525/185; 525/192; 525/240; 525/241; 525/461

(57) ABSTRACT

The present invention is a thermoplastic elastomer (TPE) composition comprising crosslinked elastomeric PVB and a thermoplastic polymer, and a process for making said TPE composition.

This application claims the benefit of U.S. Provisional Application No. 60/429,456, filed Nov. 27, 2002.

### BACKGROUND OF THE INVENTION

1. Field of the Invention

This invention relates to thermoplastic elastomers comprising polyvinylbutyral.

2. Description of the Related Art

Polyvinyl butyral (PVB) is a thermoplastic material useful for imparting shatter-resistance to glass in such applications as windshields for automobiles and window glass in homes and buildings, for example. The preparation of polyvinyl butyral is known, and is practiced commercially. For example, Butacite® is a polyvinyl butyral product manufactured by E. I. DuPont de Nemours and Company. Solutia also manufactures polyvinyl butyral products.

It is known that PVB blends with other polymer materials have utility. For example, U.S. Pat. No. 5,514,752 describes PVB/polypropylene blends, and U.S. Pat. No. 5,770,654 describes PVB/polyamide blends. U.S. Pat. No. 6,506,835 describes PVB/PVC blends. PVB can improve the flexibility, polarity and toughness of polyolefins, polyamides, and polyvinylchloride. However, use of PVB in polymer blends is not without problems.

PVB is a material that can be difficult to work with because of the tendency of PVB to adhere to itself. Sheets of PVB can stick together, or bind, with such strength that it is very difficult to separate the layers—even to the extent that the layers cannot be separated. Such irreversible self-adhesion by PVB is referred to in the art of PVB manufacture as “blocking”. Once PVB “blocks”, it can be extremely difficult, if not impossible, to process. PVB is generally stored cold to reduce the tendency to block. Refrigerated vehicles are used to ship PVB for the same reason. The tendency to block can make manufacturing processes that incorporate PVB very complex and difficult. Continuous processes that in which PVB is handled can be very expensive processes to run, and therefore are not practical commercial operations. Blends of PVB with other materials can block in the same manner as homogenous PVB compositions. Therefore, blends of PVB with other polymers can be difficult to obtain in a cost effective manner.

Thermoplastic elastomers (TPEs) are composite materials obtained from the combination of an elastomeric material and a thermoplastic material. TPEs are elastomeric materials that are dispersed and crosslinked in a continuous phase of a thermoplastic material. Examples of conventional TPEs include Santoprene®, available from Advanced Elastomers Systems, Inc. and Sarlink® available from DSM Elastomers, Inc.

TPEs are useful in many applications, including hose, tubing, liners, seals, sheeting belts, wire and cable jackets, wheels, and grips, for example. To date there are no TPEs which include PVB.

### SUMMARY OF THE INVENTION

The present invention is a thermoplastic elastomer (TPE) composition comprising crosslinked polyvinylbutyral (PVBX) and a thermoplastic polymer, wherein the thermoplastic polymer is a continuous phase of the TPE having dispersed therein the elastomeric PVBX.

In another aspect, the present invention is a process for preparing a composition comprising a PVBX elastomer dispersed in a thermoplastic polymer continuous phase comprising the step of using a crosslinking agent to crosslink a modified non-blocking PVB composition in the presence of a thermoplastic polymer to form PVBX as a dispersed elastomer in the thermoplastic polymer phase.

TPE blends that incorporate PVB can be desirable because PVB can increase adhesion, reduce color, and increase the polarity—therefore the oil resistance—of the TPEs of the present invention compared with conventional TPEs.

### DETAILED DESCRIPTION OF THE INVENTION

In one embodiment, the present invention is a TPE comprising an elastomer that is a crosslinked polyvinyl butyral (PVBX) that is obtained from a modified non-blocking polyvinylbutyral (PVB) composition. Unmodified PVB is an uncrosslinked gum that flows and masses together, that is it blocks, typically at temperatures above about 4° C. (approximately 40° F.). For this reason it is difficult to convert PVB into a blended material, particularly by a continuous process. Modified PVB useful in the practice of the present invention is free-flowing, without blocking (non-blocking) at temperatures above about 4° C. Suitable modified PVB compositions are described in U.S. Provisional Patent Application Ser. No. 60/224,126, the teachings of which are incorporated herein by reference in its entirety.

Modified PVB suitable for use in the practice of the present invention can be obtained commercially. For example, modified PVB can be purchased under the tradename of ECOCITE™ from E. I. DuPont de Nemours and Company (DuPont). Suitable modifying agents for the purposes of the present invention include, for example, Fusabond P MD-353D, Fusabond A MG-423D, and Fusabond E MB-496D, available from DuPont.

Modified PVB can be crosslinked using any crosslinking agent that is capable of reacting with the hydroxyl groups of PVB. A crosslinking agent suitable for use herein is any polyfunctional molecule wherein the crosslinking agent's functional groups are the type that can react with the hydroxyl groups of PVB to form a crosslinked network of PVB polymer molecules. Suitable crosslinking agents include poly-carboxylic acids such as a di-, tri-, and tetracarboxylic acids, for example and/or functional equivalents thereof. Functional equivalents of carboxylic acids for the purposes of the present invention include, for example, carboxylic acid esters, carboxylic acid anhydrides and mixed anhydrides, carboxylic acid halides, alkyl sulfonates, and lactones, for example. Crosslinking agents having mixed functionality may be suitable for use herein. Other suitable crosslinking agents may be known by one skilled in the art to be useful herein, and use of that agent in the present invention is not excluded because it is not listed herein. Suitable crosslinking agents include, for example: adipic acid; succinic acid; maleic acid; citric acid; ethylenediamine tetraacetic acid (EDTA); succinic anhydride; maleic anhydride; phthalic anhydride; trimellitic anhydride; pyromellitic dianhydride (PMDA); benzophenone tetracarboxylic acid dianhydride (BTDA); poly(methyl vinyl ether, comaleic anhydride); and poly(styrene, comaleic anhydride); isomers of terephthalic acid; and succinic acid half-methyl ester; 4,4′-methylene diphenyl diisocyanate (MDI); 2,4-toluene diisocyanate (TDI); diisocyanate oligomers such as, for example, TDI-terminated poly(propylene glycol), TDI-terminated poly(ethylene adipate), TDI-terminated poly(1,4-butanediol), and/or TDI-terminated poly(ethylene glycol); naphthalene diisocyanate (NDI); hexamethylene diisocyanate (HDI); p-phenylene diisocyanate (PPDI). Suitable crosslinking agents can also include, for example: diepoxides such as: glycerol diglycidyl ether; neopentylglycol glycidyl ether; bisphenol A diglycidyl ether; poly(propylene glycol) diglycidyl ether; ethylene glycol glycidyl ether; 1,4-butanediol diglycidyl ether; and, polyethylene glycol diglycidyl ether. Suitable crosslinking agents can also include, for example: silanes such as 3-aminopropyl triethoxysilane, vinyl triethoxysilane; vinyltrimethoxy silane. Suitable crosslinking agents can also include, for example: phenolics such as octyl phenol-formaldehyde resin; dimethylol phenolic resin. Suitable crosslinking agents can also include, for example: melamine resins.

PVBX is an elastomer that can be formed after reacting PVB or modified PVB with a crosslinking agent. Conventional PVB can be difficult to use in polymeric blends, and so use of modified PVB is preferred in the practice of the present invention.

PVBX can be included in the TPE in an amount of from about 1 wt % to about 99 wt % of the total weight of the TPE. Preferably the PVBX is included in an amount of from about 25 wt % to about 95 wt %, more preferably in an amount of from about 50 wt % to about 90 wt %, and most preferably in an amount of from about 75 wt % to about 90 wt %.

The thermoplastic polymer can be any that forms a discrete phase, but shows functional compatibility, with PVB or modified PVB. For example, the thermoplastic polymer can be a polyolefin such as polypropylene or polyethylene, including high density polyethylene (HDPE); polyvinylchloride; polyamides; polycarbonate; polyacrylic acid; polyacrylate; polymethyl methacrylate; polystyrene; styrenic copolymers; polyvinylidene chloride; polyesters; polyacetals; copolyesters; and, polysulfones. The thermoplastic polymer can be included in an amount of from about 99 wt % to about 1 wt %, preferably in an amount of from about 75 wt % to about 5 wt %, more preferably from about 50 wt % to about 10 wt %, and most preferably from about 25 wt % to about 10 wt %.

In another embodiment, the present invention is a process for preparing a TPE comprising PVBX and a thermoplastic polymer. In the present invention, modified PVB is crosslinked to form the PVBX elastomer of the present invention. The modified PVB can either be formed from the reaction of PVB and a modifying agent, or modified PVB can be purchased commercially. The preparation of modified PVB is described in detail in U.S. Provisional Patent Application Ser. No. 60/224,126. To prepare modified PVB, for example, PVB can be heated in the presence of a modifying agent which has hydroxyl-reactive groups such as the anhydride functionality of Fusabond® P, obtained commercially from E. I. DuPont de Nemours and Company, for example.

A catalyst can be optional for the crosslinking reaction, depending on the nature of the crosslinking agent. It is preferred that a catalyst be used to facilitate the crosslinking reaction. One skilled in the art will know what catalyst is suitable, depending on the identity and functionality of the crosslinking agent. For example, conventional catalysts for esterification reactions can be used if the crosslinking agent is a polycarboxylic acid, or conventional transesterification catalysts can be used if the crosslinking agent is an ester. Divalent tin catalysts, for example, are suitable for use herein. For example, stannous octanoate, stannous acetate, and stannous chloride can be useful catalysts for the purposes described herein. Conversely, peroxide catalysts are not useful in the practice of the present invention. The amount of catalyst added can also be dependent upon the nature of the reactants. One skilled in the art will know that the more catalyst added, the faster the reaction will take place generally. It is within the skill of one of ordinary skill in the art to determine the appropriate levels of catalyst required for the particular crosslinking reaction.

Other optional components can be added such as antioxidants, pigments, dyes, fillers, plasticizers and the like. For example, fillers such as carbon black, talc, calcium carbonate, and clays can be suitable for use herein. Plasticizers such as diisononylphthalate (DINP), di-2-ethylhexyl azelate, adipic acid polyesters, azaleic acid polyesters, tri-2-ethylhexyl trimellitate are also suitable for use herein. Antioxidants suitable for use herein include, Irganox 1010 available from Ciba Specialty Chemicals, Inc. and Ethanox 702 available from Albemarle Corp.

Preferably, TPEs of the present invention will have a tensile strength (max) of greater than 800 psi, and an elongation of greater than 200%.

### EXAMPLES

The Examples and Comparative Examples are presented for illustrative purposes only, and are not intended to limit the scope of the present invention in any manner.

In the Examples, for each blend the components, with the exception of a crosslinking agent, were blended in a Haake/Brabender mixer at 200° C.@100 to 150 rpm in the proportions indicated in Table 1, until the mixture becomes homogeneous. The temperature was then increased to 230° C. and the crosslinking agent was added to the blend, and mixing continued for 2 minutes after the torque levels out. Each blend was removed from the blender and quickly pressed flat and quenched in dry ice, and then dried in a vacuum oven at room temperature. The Comparative Example did not include adipic acid.

TABLE 1

| | Wt. % in Ex. | Wt. % in | Wt. % in | Wt. % in |
|---|---|---|---|---|
| Component | 1^{a} | Ex. 2 | Ex. 3 | Ex. 4 |
| Polypropylene¹ | 13.9 | 13.7 | 13.6 | 13.4 |
| PVB | 83.2 | 82.1 | 81.5 | 80.4 |
| Fusabond P² | 2.8 | 2.7 | 2.7 | 2.7 |
| Stannous | 0 | 0.7 | 0.7 | 0.7 |
| acetate | | | | |
| Adipic acid | 0 | 0.7 | 1.4 | 2.7 |
| Irganox ® 1010 | 0.1 | 0.1 | 0.1 | 0.1 |

¹Profax 6323
²MD-353D
^{a}Comparative Example, not an example of the present invention.
The blends were tested, and the results are given in Table 2.

TABLE 2

| Property | Ex. 1 | Ex. 2 | Ex. 3 | Ex. 4 |
|---|---|---|---|---|
| MI¹ @ 190° C., 2160 g | 4.8 | 0.6 | 0.2 | 0.0 |
| MI¹ @ 190° C., 21.6 kg | — | — | 67 | 14 |
| Tensile Strength Max (PSI) | 3817 | 3106 | 3315 | 869 |
| Elongation @ MAX (%) | 285 | 243 | 243 | 89 |
| Shore A (0/15 sec) | 77/68 | 81/72 | 85/74 | 82/68 |
| Shore D (0/15 sec) | 54/23 | 53/22 | 54/25 | 53/22 |
| Compression Set² (%) | 48/113 | 46/113 | 42/106 | 32/75 |

¹MI = melt index
²@ 23° C. & 100° C.

The blends described in Table 3 were prepared as described for the Examples in Table 1, except that all ingredients except for DINP were blended at 180° C. until homogeneous, then DINP was added and blended for 1 minute. Samples were removed, pressed flat, quenched in dry ice, then dried in a vacuum oven at room temperature.

The peroxide crossling agent of Table 3 is ineffective in crosslinking PVB, as evidenced by the lack of significant reduction in melt indices and compression sets.

TABLE 3

| | Wt. % in | Wt. % in | Wt. % in | Wt. % in |
|---|---|---|---|---|
| Component | Ex. 5^{a} | Ex. 6^{a} | Ex. 7^{a} | Ex. 8^{a} |
| Polyvinyl chloride¹ | 16.1 | 16.1 | 16.0 | 15.9 |
| PVB | 64.5 | 64.3 | 64.1 | 63.7 |
| Fusabond MG 423D | 3.2 | 3.2 | 3.2 | 3.2 |
| DINP | 16.1 | 16.1 | 16.0 | 15.9 |
| Luperco 231XL | 0 | 0.32 | 0.64 | 1.27 |

¹E80428-68
^{a}Comparative Example, not an example of the present invention.

The blends were tested, and the results are given in Table 4.

TABLE 4

| Property | Ex. 5^{a} | Ex. 6^{a} | Ex. 7^{a} | Ex. 8^{a} |
|---|---|---|---|---|
| MI¹ @ 190° C., 2160 g | 0.7 | 1.3 | 1.4 | 3.5 |
| MI¹ @ 190° C., 21.6 kg | 192 | 207 | 192 | 295 |
| Tensile Strength Max (PSI) | 2584 | 2405 | 2534 | 2323 |
| Elongation @ MAX (%) | 342 | 339 | 346 | 346 |
| Shore A (0/15 sec) | 82/68 | 80/64 | 78/63 | 76/60 |
| Shore D (0/15 sec) | 51/20 | 45/17 | 50/18 | 45/16 |
| Compression Set² (%) | 49/96 | 49/101 | 44/111 | 47/106 |

¹MI = melt index
²@ 23° C. & 100° C.
^{a}Comparative Example, not an example of the present invention.

The crosslinking agents of Table 5 were effective crosslinking agents as evidenced by the reduction of melt indices and compression sets versus the comparative Example 8, in Table 6.

TABLE 5

| | | | | | PEA | | | A-1100 | |
|---|---|---|---|---|---|---|---|---|---|
| Ex. No. | PP¹ | Mod G² | MDI³ | TDI⁴ | (TDI)⁵ | BTDA⁶ | EGDE⁷ | Silane⁸ | R-7500⁹ |
| 8 | 50 | 50 | 0 | 0 | 0 | 0 | 0 | 0 | 0 |
| 9 | 49.5 | 49.5 | 1.0 | 0 | 0 | 0 | 0 | 0 | 0 |
| 10 | 46.5 | 46.5 | 0 | 7.0 | 0 | 0 | 0 | 0 | 0 |
| 11 | 41.7 | 41.7 | 0 | 0 | 16.7 | 0 | 0 | 0 | 0 |
| 12 | 49.5 | 49.5 | 0 | 0 | 0 | 1 | 0 | 0 | 0 |
| 12A | 47.6 | 47.6 | 0 | 0 | 0 | 4.8 | 0 | 0 | 0 |
| 13 | 43.5 | 43.5 | 0 | 0 | 0 | 0 | 13.0 | 0 | 0 |
| 14 | 45.5 | 45.5 | 0 | 0 | 0 | 0 | 0 | 9.0 | 0 |
| 15 | 41.7 | 41.7 | 0 | 0 | 0 | 0 | 0 | 0 | 16.6 |

¹Profax 6323;
²See Table 6;
³4,4′ methylene bis(phenyl isocyanate);
⁴2,4 toluene diisocyanate;
⁵poly(ethylene adipate) TDI terminated;
⁶benzophenone tetra carboxylic dianhydride;
⁷ethylene glycol diglycidyl ether;
⁸3-aminopropyl triethoxy silane;
⁹octyl-phenol formaldehyde resin

TABLE 6

| | Melt | Melt | Shore | Compression |
|---|---|---|---|---|
| Ex. No. | Index¹ | Index² | D | Set @ 70° C. |
| 8 | 6 | 124 | 58 | 93 |
| 9 | 0 | 10 | 62 | 82 |
| 10 | 0 | 16 | 67 | 81 |
| 11 | 0 | 18 | 50 | 81 |
| 12 | 0 | 19 | 63 | 80 |
| 12A | 0 | 11 | 65 | 83 |
| 13 | 0 | 30 | 49 | 93 |
| 14 | 0 | 22 | 64 | 90 |
| 15 | 0 | 48 | 63 | 90 |

¹@ 190° C., 2160 g
²@ 190° C., 10 kg

What is claimed is:

1. A thermoplastic elastomer (TPE) composition comprising crosslinked polyvinylbutyral (PVBX) and a thermoplastic polymer, wherein the thermoplastic polymer is a continuous phase of the TPE having dispersed therein the elastomeric PVBX.

2. The composition of claim 1 wherein the PVBX is present in an amount of from about 25 wt % to about 95 wt %.

3. The composition of claim 2 wherein the PVBX is present in an amount of from about 50 wt % to about 90 wt %.

4. The composition of claim 3 wherein the PVBX is present in an amount of from about 75 wt % to about 90 wt %.

5. The composition of claim 1 wherein PVBX is the product of the crosslinking reaction between modified PVB and crosslinking agents selected from the group consisting of: polycarboxylic acids or functional equivalents thereof; diisocyanates; and diisocyanate oligomers.

6. The composition of claim 1 wherein the continuous phase is at least one thermoplastic polymer selected from polymers in the group consisting of: polypropylenes; polyethylenes; polyvinylchlorides; polystyrenes; polyamides; polycarbonates; poly(acrylic acid); polyacrylates; poly(methy methacrylates); styrenic copolymers; polyvinylidene chlorides; polyesters; polyacetals; copolyesters; and polysulfones.

7. The composition of claim 6 wherein the continuous phase is polypropylene or polyvinylchloride.

8. The composition claim 7 wherein the continuous phase is polypropylene.

9. The composition of claim 1 wherein the thermoplastic polymer is present in an amount of from about 75 wt % to about 5 wt %.

10. The composition of claim 9 wherein the thermoplastic polymer is present in an amount of from about 50 wt % to about 10 wt %.

11. The composition of claim 10 wherein the thermoplastic polymer is present in an amount of from about 25 wt % to about 10 wt %.

12. A process for preparing a composition comprising a PVBX elastomer dispersed in a thermoplastic polymer continuous phase comprising the step of using a crosslinking agent in a crosslinking reaction to crosslink a modified non-blocking PVB composition in the presence of a thermoplastic polymer to form PVBX as a dispersed elastomer in the thermoplastic polymer phase.

13. The process of claim 12 wherein the crosslinking agent is an agent selected from the group consisting of: polycarboxylic acids or functional equivalents thereof; diisocyanates; and diisocyanate oligomers.

14. The process of claim 13 wherein a catalyst is used to catalyze the crosslinking reaction.

15. A process for preparing a composition comprising a PVBX elastomer dispersed in a thermoplastic polymer continuous phase comprising the steps of: (1) combining PVB, a thermoplastic polymer, and a PVB modifying agent; (2) modifying PVB in the presence of the thermoplastic polymer to form a modified non-blocking PVB/thermoplastic polymer mixture and (3) using a crosslinking agent to crosslink the modified non-blocking PVB/thermoplastic polymer composition to form PVBX as a dispersed elastomer in the thermoplastic polymer phase.

16. An elastomeric crosslinked polyvinylbutyral composition (PVBX) obtained by a process comprising the steps: (1) heating PVB in the presence of a modifying agent to obtain a non-blocking PVB composition (2) heating the modified PVB composition in the presence of a PVB crosslinking agent and a catalyst, wherein the conditions are sufficient for a crosslinking reaction to take place between PVB and the crosslinking agent, to obtain the elastomeric PVBX.

17. An article prepared from the TPE composition of claim 1.

18. The article of claim 17 wherein the article is a hose, tube liner, seal, sheet, belt, wire and cable jacket, wheel, shoe sole, film, or grip.
